(19) United States
(12) Patent Application Publication
(10) Pub. No.: US 2019/0059579 A1
(43) Pub. Date: Feb. 28, 2019

(54) INDUSTRIAL RACKING SYSTEM

(71) Applicant: Industrial Manufacturing Services, Lancaster, SC (US)

(72) Inventor: Warren Ashley Earl, Great Falls, SC (US)

(21) Appl. No.: 15/693,399

(22) Filed: Aug. 31, 2017

(51) Int. Cl. A47B 57/34; B65D 19/40; B65G 1/02

(52) U.S. Cl. CPC A47B 57/34; B65D 2519/00796; B65G 1/02; B65D 19/40

(57) ABSTRACT

The subject matter described herein includes an industrial racking system. The industrial racking system includes at least two sidewalls including rows of apertures spaced from each other. The industrial racking system further includes at least one row of removable support members for extending between the sidewalls, engaging corresponding rows of apertures in the sidewalls, and engaging channels located on an underside of a pallet or industrial article.

### TECHNICAL FIELD

The subject matter described herein relates to an industrial racking system for holding welding fixtures or other industrial articles.

### BACKGROUND

Industrial racking systems are used in manufacturing and other facilities to hold industrial articles, including, but not limited to welding fixtures, parts, tools, finished products, etc. Desirable characteristics of the racking systems include adjustability, stability, strength, and safety in an industrial environment.

Racking systems with adjustable height shelves exist. However, a typical racking system is designed to hold articles placed on top of a flat shelf. While such a system may be suitable for some applications, articles stored on flat shelves can move or be knocked off of the shelf. Even with articles are placed on the pallets, the pallet can move with respect to the shelf, creating a falling hazard. In addition, if the shelf extends across the entire width of the racking system, adjustment in shelf height can only occur on a per shelf basis, which results in adjustability that is less granular than desired. For example, if industrial articles of varying heights need to be placed on a shelf and the height of the shelf is only adjustable across the entire width of the industrial racking system, space may be wasted because the shelf height must be set for the tallest article present on the shelf.

Accordingly, in light of these difficulties, there exists a need for an improved industrial racking system.

### SUMMARY

The subject matter described herein includes an industrial racking system. The industrial racking system includes

at least two sidewalls including rows of apertures spaced from each other. The industrial racking system further includes at least one row of removable support members for extending between the sidewalls, engaging corresponding rows of apertures in the sidewalls, and engaging channels located on an underside of a pallet or industrial article.

According to another aspect, the subject matter described herein includes an industrial racking system. The system includes a plurality of pairs of sidewalls including rows of apertures that are spaced from each other. The system further includes a plurality of rows of removable support members for extending between a pair of the sidewalls, engaging corresponding rows of apertures in the sidewalls, and defining adjustable height cells for holding industrial articles. The system further includes a plurality of pallets, each having an underside with channels for at least partially surrounding the removable support members in one of the rows and an upper surface for holding the industrial articles.

According to yet another aspect, the subject matter described herein includes a pallet for an industrial racking system. The pallet includes an upper surface for holding industrial articles. The pallet further includes an underside with parallel channels for at least partially surrounding removable support members of row of the removable support members in an industrial racking system. The pallet further includes at least one fork receiving aperture located between the upper surface and the underside of the pallet for receiving forks of a fork lift.

### BRIEF DESCRIPTION OF THE DRAWINGS

FIG. 1 is a perspective view of an industrial racking system;

FIG. 2 is a close up view of a pallet and a row of support members in an industrial racking system;

FIG. 3A is a side view of a pallet for use in an industrial racking system;

FIG. 3B is a perspective view showing the underside of a pallet for an industrial racking system;

FIG. 4 is a close up view of industrial fixtures located in an industrial racking system;

FIG. 5 is a side view of a side wall of an industrial racking system; and

FIG. 6 is a close up view of a sidewall of an industrial racking system.

### DETAILED DESCRIPTION

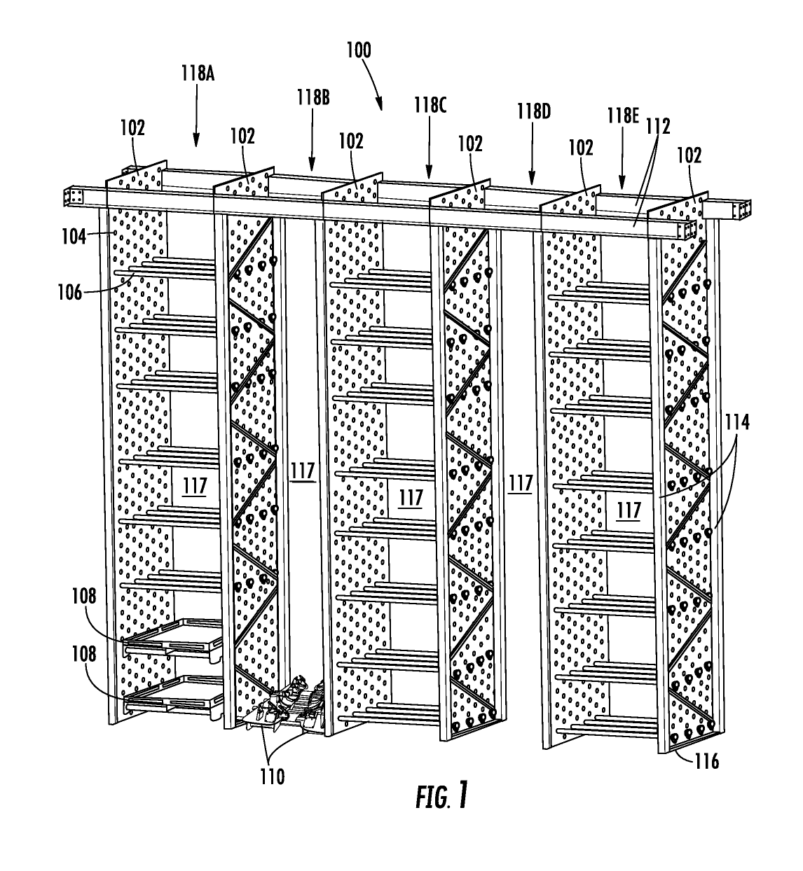

An industrial racking system with sidewalls and support members that engage apertures in adjacent sidewalls is disclosed. FIG. 1 is a perspective view of an industrial racking system. Referring to FIG. 1, racking system 100 includes a plurality of sidewalls 102. Sidewalls 102 may each comprise rectangle members with horizontal rows of apertures 104. Apertures 104 are configured to receive removable support members 106. Removable support members 106 extend between corresponding rows of apertures 104 in adjacent sidewalls 102. Removable support members 106 are configured to engage channels that extend across the underside of pallets 108 or industrial articles 110. As will be described in more detail below, removable support members 106 are removable from apertures 104 and can be reinserted in other rows of apertures 104 to adjust the height of a cell is designed to hold either a pallet 108 or an industrial article 110.

In the examples described herein, support members 106 are cylindrical in profile or cross section and may hollow tubes formed of a metallic material, such as iron or aluminum. However, any suitable shape and material for supporting pallets and industrial articles is intended to be within the scope of the subject matter described herein. In general, support members 106 may be polygonal (e.g., square, circular, triangular, rectangular, etc.) as long as support members 106 fit within apertures 104 and are capable of engaging channels formed across the undersides of pallets.

In the illustrated example, sidewalls 102 are joined together via I-beam support members 112. Sidewalls 102 are also supported in the vertical direction by vertical support members 114. Vertical support members 114 may be bolted to the floor of an industrial facility via support plates 116. It should also be noted that horizontal I-beam structures 112 may be integrated with ceiling support structure of an industrial facility. Alternatively, racking system 100 maybe free standing and separate from the ceiling support structure of the industrial facility in which racking system is located.

Rather than having shelves that extend across the entire length of industrial racking system 100, sidewalls 102 are horizontally spaced from each other between the ends of industrial racking system 100 and form columns of article holding cells 117 between the ends of racking system 100. In the illustrated example, a first column 118A includes plural cells 117 formed by sidewalls 102 and vertically spaced rows of support members 106. A second column 118B includes a single cell 117 formed by sidewalls 102 and a row of support members 106 extending between the lowermost rows of apertures in sidewalls 102. Column 118C includes plural cells 117. It should be noted that the height of each cell 117 is adjustable independently from the height of cells in adjacent columns (unless a row in an adjacent column is occupied by support members 106). Thus, rather than having cells that are adjustable across the entire width of racking system 100, racking system 100 is divided into columns that include cells whose height is independently adjustable with respect to cells in adjacent columns. Column 118D does not include any support members 106 but can include a configurable number of rows of support members 106. Column 118E is divided into cells similar to columns 118A-118C.

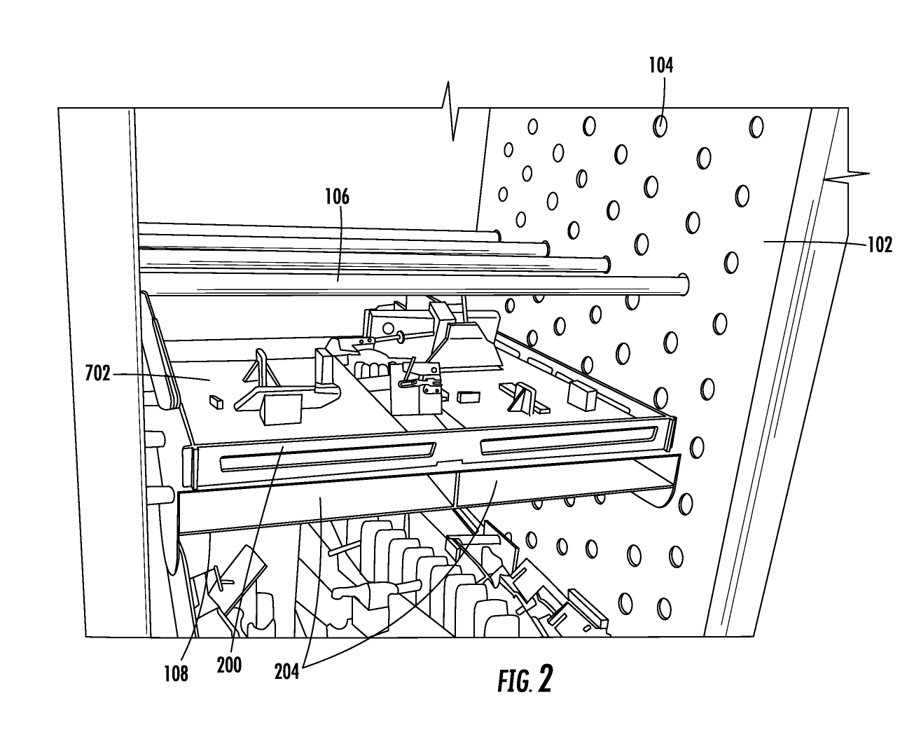

FIG. 2 is a close up view of pallet 108 located in one column of racking system 100. One example, pallet 108 includes a pallet fence 200 extending around a perimeter of an upper surface of pallet 108 for preventing industrial articles 202 from sliding horizontally off of the upper surface of pallet 108. Pallet 108 also includes fork receiving apertures 204 for receiving forks of a fork lift that allows pallet 108 to be lifted from support members 103 and moved from racking system 100. In addition, fork receiving apertures 204 allow a pallet 108 that is not located in racking system 100 to be lifted by a fork lift moved above a row of support members, and lowered until channels located on the underside of pallet 108 are engaged by support members 106.

In FIG. 2, pallet 108 includes two fork receiving apertures 204 located between the upper surface and the underside of pallet 108. In an alternate implementation, pallet 108 may include a single aperture for receiving both forks of a fork lift.

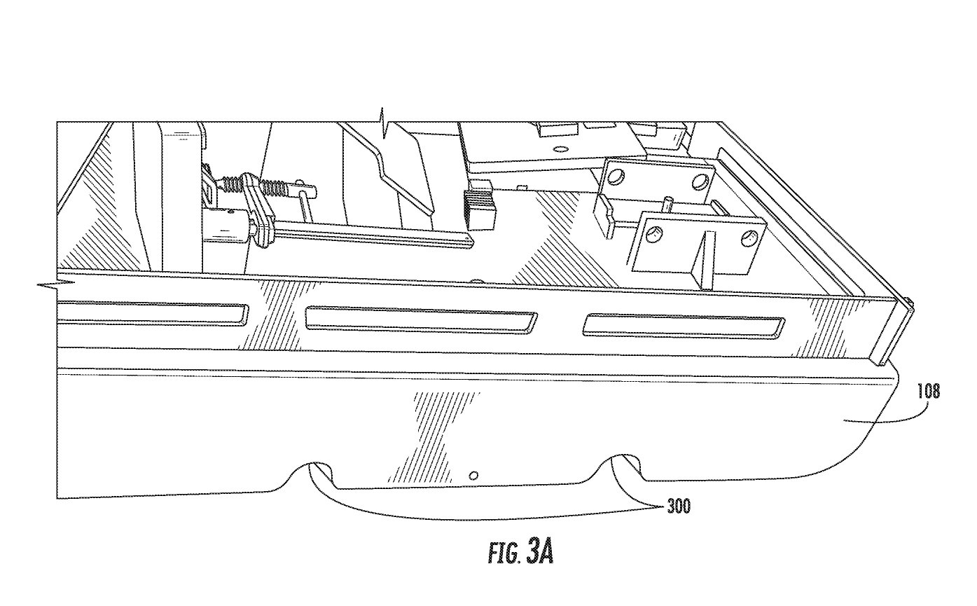

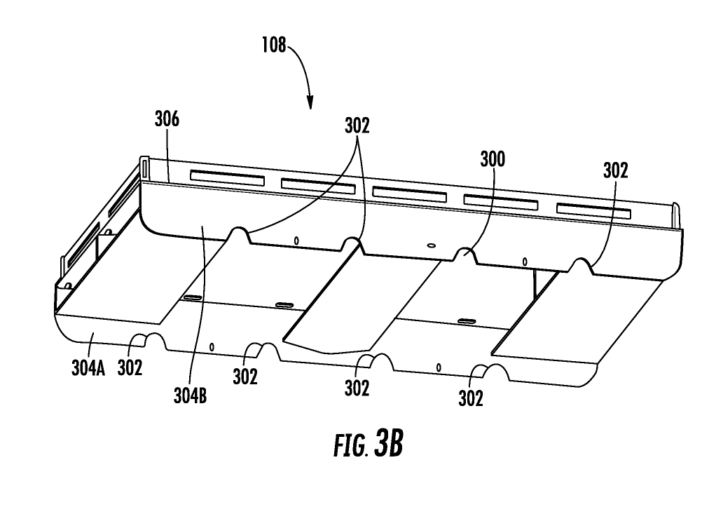

FIG. 3A is side view of pallet 108. It can be seen from FIG. 3A that pallet 108 includes channels 300 located in a lower surface of pallet 108 for receiving support members 106. Channels 300 may extend laterally across the underside of each pallet 108 and may be designed to surround a portion of the outer surface of each support member 106. Because channels 300 are configured to surround at a portion of the outer surface of each support member 106, pallets 108 are stably positioned in racking system 100. For example, when a fork lift lowers a pallet 108 onto a row of support members 106, support members 106 engage channels 300 and pallet 108 is prevented from moving forward or backward in the industrial racking system. Similarly, when a fork lift places an article on pallet 108 or places another pallet 108 in industrial racking system 100 adjacent to an existing pallet, channels 300 prevent the existing pallet from moving within racking system 100.

FIG. 3B is a perspective view of the underside of an exemplary pallet 108. In FIG. 3B, channels 300 that engage support members 106 are formed by cutouts 302 in opposing sidewalls 304A and 304B that extend downwardly from lateral edges of upper surface 306 of pallet 108. For simplicity, only a single channel 300 is labeled in FIG. 3B. Each channel 300 is formed by a pair of corresponding cutouts 302 in opposite sidewalls 302A and 302B and the space between the corresponding cutouts 302 that extends laterally across the underside of pallet 108.

In the illustrated example, cutouts 302 each have a semi-cylindrical profile for receiving support members 106 with cylindrical cross sections. However, cutouts 302 may have any suitable profile that is capable of fitting over support members 106 of any suitable shape or cross section and preventing or reducing forward or backward pallet movement when pallet 108 is placed within industrial racking system 100. Such forward or backward movement of a pallet 108 may be achieved by lifting pallet 108 from support members 106 such that support members 106 are outside of cutouts 302 but not when support members 106 engage cutouts 302. As a result, undesirable forward or backward movement of pallet 108 when pallet 108 is placed within industrial racking system 100 is reduced.

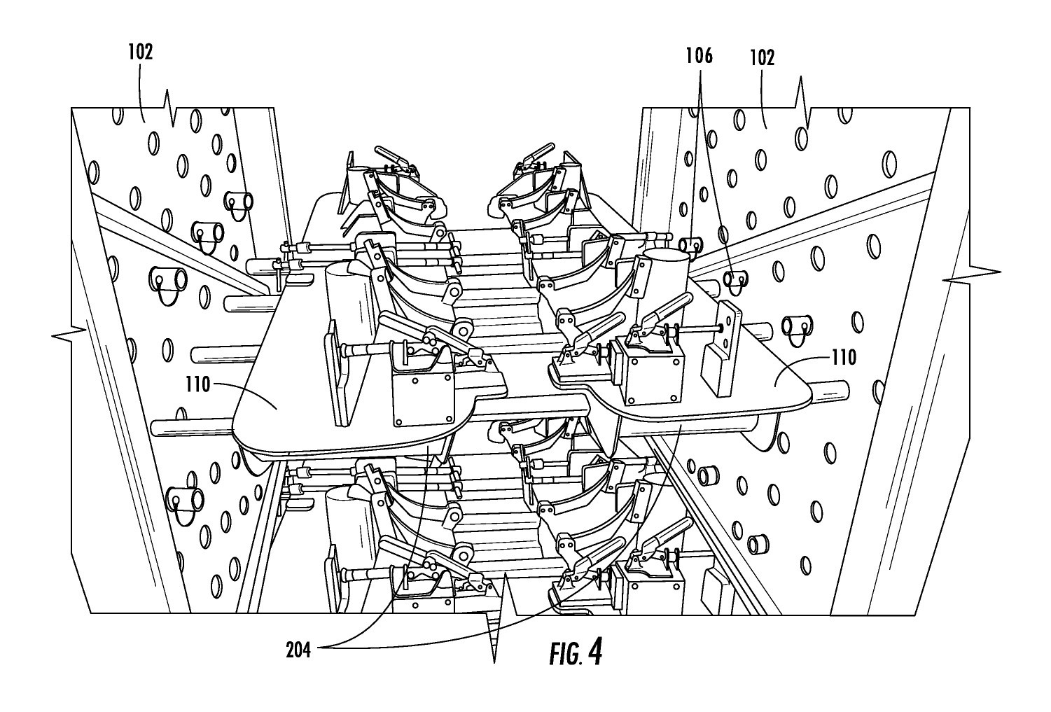

In another example, industrial articles 110, such as welding fixtures, maybe placed directly onto support members 106 without using a pallet. FIG. 4 illustrates such an example. In FIG. 4, industrial articles 110 are place directly on support members 106 between sidewalls 102 in racking system 100. Industrial articles 110 in the illustrated example comprise welding fixtures. However, any industrial article that can be configured with channels, such as those illustrated in FIGS. 3A and 3B, are intended to be within the scope of the subject matter herein. Thus, industrial articles 110 may each include an underside such as that illustrated in FIGS. 3A and 3B with channels 300 for engaging support members 106. Each industrial article 110 may also include fork receiving aperture 104 for receiving a fork of a forklift. Industrial articles 110 may also include sidewalls 304A and 304B extending downwardly from opposite lateral edges of each industrial article 110, and sidewalls 304A and 304B may include cutouts 302, similar to those illustrated and described above with respect to FIG. 3B.

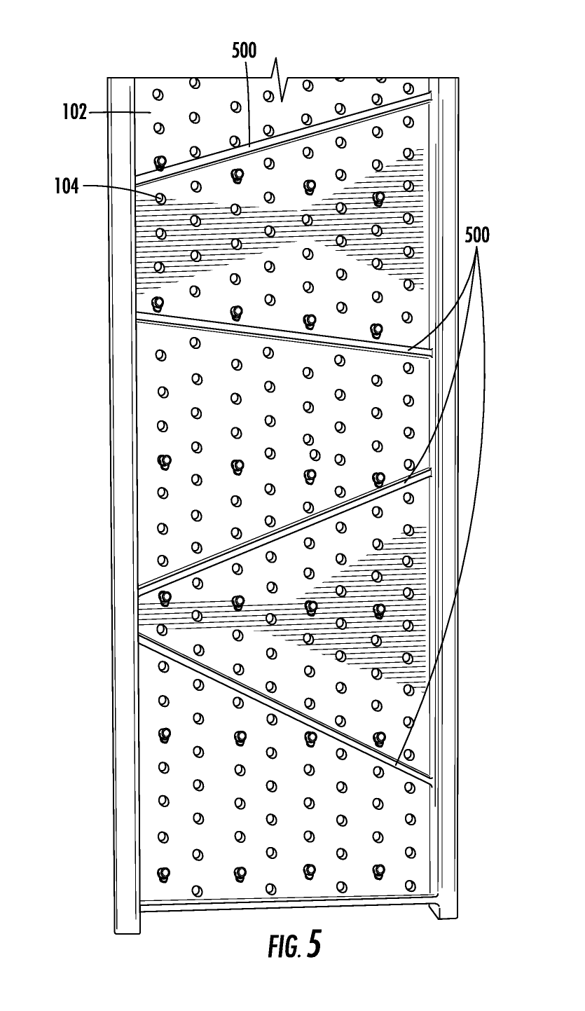

FIG. 5 is a side view of sidewall 102. In FIG. 5, it can be seen that apertures in adjacent horizontal rows are offset from each other. The reason that apertures 104 in adjacent rows are offset from each other is to increase the strength of sidewalls 102. Sidewall 102 also includes stiffening members 500 for increasing the strength of sidewall 102.

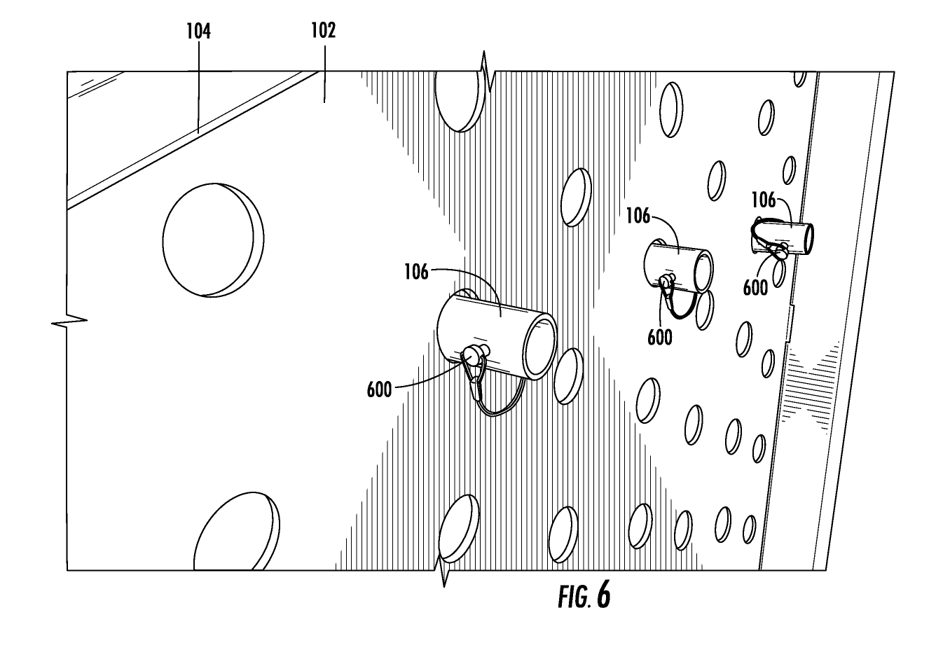

FIG. 6 is a close up view of sidewall 102 illustrating apertures 104 and support members 106 that is extending through apertures 104. In the illustrated example, each support member 106 includes a locking member 600 for locking support members 106 into apertures 104. In the illustrated example, locking members 600 cotter pins that engage radial apertures bored in the end of each support member 106.

It can also be seen in FIG. 6 that each support member 106 comprises a tube defining a hollow interior region. However, each support member may be solid in cross section without departing from the scope of the subject matter described herein. The choice of material for support members 106 depends on the desired weight bearing characteristics. In one example, support members 106 may be made of a metal, such as iron, steel, or aluminum. Sidewalls 102 may also be made of metal that can be formed into sheets, such as iron, steel, or aluminum.

Thus, the subject matter described herein includes a racking system with adjustable height cells made from sidewalls and support members that engage channels located from the undersides of pallets or industrial articles. Such a system is an improvement over existing systems due to the stability of the pallets or industrial articles when engaging support members. Such a system also has increased adjustability over systems where the shelf extends the entire length of the racking system is the smallest unit of adjustment.

1. An industrial racking system comprising:
at least two sidewalls including rows of apertures spaced from each other; and
at least one row of removable support members for extending between the sidewalls, engaging corresponding rows of apertures in the sidewalls, and engaging channels located on an underside of a pallet or industrial article
a welding fixture having channels for receiving the removable support members, the welding fixture configured to be placed directly onto the removable support members without using a pallet.

2. The system of claim 1 comprising a pallet having channels for receiving the removable support members and an upper surface for holding industrial articles.

3. The system of claim 2 wherein the pallet comprises first and second sidewalls extending downwardly from lateral edges of the upper surface, wherein corresponding cutouts in the first and second sidewalls form the channels.

4. (canceled)

5. The system of claim 2 comprising a fence extending around a perimeter of the upper surface of the pallet for holding industrial articles.

6. The system of claim 2 wherein the pallet includes at least one fork receiving aperture for receiving forks of a forklift.

7. (canceled)

8. The system of claim 1 wherein the welding fixture comprises first and second sidewalls extending downwardly from lateral edges of the welding fixture and corresponding cutouts in the first and second sidewalls form the channels.

9. The system of claim 1 wherein adjacent rows of apertures in the sidewalls are offset from each other.

10. The system of claim 1 wherein the removable support members each comprise a cylindrical tube having a hollow interior region.

11. The system of claim 1 comprising locking members for locking the removable support members in the apertures.

12. The system of claim 1 wherein the at least one row of removable support members is moveable between the rows of apertures in the sidewalls to adjust height of a cell for holding the pallet or industrial article.

13. The system of claim 12 wherein the cell comprises a unit of adjustment that is less than a width of the industrial racking system.

14. An industrial racking system comprising:
a plurality of pairs of sidewalls including rows of apertures that are spaced from each other, wherein the sidewalls include a first pair of sidewalls forming a first column of adjustable height article holding cells and a second pair of sidewalls laterally spaced from the first pair of sidewalls and forming a second column of adjustable height article holding cells;
a plurality of rows of removable support members for extending between a pair of the sidewalls, engaging corresponding rows of apertures in the sidewalls, and defining adjustable height cells for holding industrial articles, the removable support members including a first sent of removable support members extending between the sidewalls in the first column of adjustable height article holding cells and a second set of removable support members extending between the sidewalls in the second column of adjustable height article holding cells, wherein the first and second sets of removable support members are adjustable independently from each other to respectively and separately adjust the height of the cells in the first and second columns.
a plurality of pallets, each having an underside with channels for at least partially surrounding outer surfaces of each of the removable support members in one of the rows and an upper surface for holding the industrial articles.

15. The system of claim 14 wherein the support members each comprise a tube defining a hollow interior region.

16. (canceled)

17. (canceled)

18. (canceled)

19. (canceled)

20. (canceled)
